(19) United States
(12) Patent Application Publication
(10) Pub. No.: US 2013/0181077 A1
(43) Pub. Date: Jul. 18, 2013

(54) Concentrator Apparatus for Recovering Lead or Other Material

(71) Applicants: Darrell L. Harris, Oregon City, OR (US); Jerry E. Marks, Beavercreek, OR (US)

(72) Inventors: Darrell L. Harris, Oregon City, OR (US); Jerry E. Marks, Beavercreek, OR (US)

(21) Appl. No.: 13/553,781

(22) Filed: Jul. 19, 2012

Related U.S. Application Data
(60) Provisional application No. 61/509,552, filed on Jul. 19, 2011.

(51) Int. Cl. B02C 23/10; B02C 23/18; B07B 1/22

(52) U.S. Cl. CPC B02C 23/10; B07B 1/22; B02C 23/18
USPC 241/38; 209/288; 241/79

(57) ABSTRACT

A concentrator device for recovering lead, gold or other heavier matter from soil, gravel or another substrates. The concentrator may have an inner cylinder with screens and an outer cylinder with baffles. Various baffle arrangements are disclosed. A variable speed motor may drive rotation of the outer cylinder and a pre-processing hopper may be used to break up input soil. The hopper may include mechanical and/or water based components to separate the recovery object from the substrate it is in. Various screen configurations for the inner cylinder are disclosed, as are related aspects of the present invention.

### CROSS REFERENCE TO RELATED APPLICATIONS

This application claims the benefit of U.S. Provisional Application No. 61/509,552, filed Jul. 19, 2011, and having the same title and inventor(s) as above.

### FIELD OF THE INVENTION

The present invention relates to devices that separate and accumulate, i.e., “concentrate,” heavier objects, particularly heavier metals or like substances, from soil or other substrates. More specifically, the present invention relates to recovering lead shot or similar metals from soil, gravel or other substrates.

### BACKGROUND OF THE INVENTION

Lead has long been used in the making of bullets and shot, among other products. During the mid and late 20^{th} century, concern grew about the negative human health impacts of lead and in response to these concerns lead was banned from paint and other products. It has not been banned from shot or bullets.

Lead, as it breaks down, forms lead oxide (several lead oxides are known). Lead oxide may be fatal if swallowed or inhaled. It causes irritation to skin, eyes, and respiratory tract. Lead oxide is known to affect gum tissue, central nervous system, kidneys, blood, and reproductive system. In developing humans and other organisms, it can cause brain damage. Furthermore, it can bioaccumulate in plants and in mammals making its release into the environment that much more problematic.

It is the oxide of lead, as opposed to lead itself, that is the principal malevolent agent.

Given the significant negative impacts of lead oxide, efforts are being made to reduce the prevalence of lead in the environment. There is an emerging trend toward recovery of lead from the environment where possible and practical.

One example is the recovery of lead from shooting ranges. Most communities in the U.S. (and around the world) have shooting ranges. Some date back centuries. These ranges may have a significant accumulation of lead. As lead breaks down, i.e., oxidizes, the lead oxide can move through soil with rain and ground water movement and pollute nearby water sources—ground water or surface water. This presents a significant health risk. Furthermore, as communities expand, new subdivisions and housing tracts may be built over former shooting ranges, resulting in contaminated soil in the home garden. Alternatively, former shooting range lands may be converted for agricultural production, potentially yielding tainted crops.

U.S. Pat. No. 4,178,238 (the '238 patent) discloses a device for separating or concentrating lead shot from soil. This device discloses two concentric cylinder chambers that are mounted on a trailer and configured for tiltable and rotatable movement. The inner cylinder has screens and is thus configured as a trommel (a rotating screened cylinder). The outer cylinder has a plurality of rib members that function in conjunction with water flow to separate lighter particles from heavier particles, thus separating soil and lighter rock particles from lead.

The device of the '238 patent is disadvantageous, however, for several reasons including that it is not effective for processing larger clumps of soil (which pass through unprocessed), it utilizes a rib member or “baffle” arrangement that frequently clogs, the screen openings are of one fixed size that limit processing, and water is not use more effectively to saturate and dissolve soil which aids significantly in lead-soil separation, among other shortcomings.

A need exists for a concentrator that effectively chops up, saturates and breaks down soil and soil clumps that may contain lead (or another target). A further need exists for a concentrator that includes one or more of: refined and changeable screen arrangements, a more effective baffle structure, and a water delivery system that uses water to effectively dissolve soil away from the target recoverable. Moreover, a need exists for a motor and control configuration that yields greater control over the various components of the system to increase efficacy of separation/recovery.

### BRIEF DESCRIPTION OF THE DRAWINGS

FIG. 1 is a side elevation view of a concentrator device in accordance with the present invention.

FIGS. 2 and 3 are a perspective and a cross-sectional view of a hopper or pre-processor for the device of FIG. 1.

FIG. 4 is a cross-sectional view of a concentration chamber of the device of FIG. 1.

FIGS. 5 and 6 are side views of two different embodiments of an inner cylinder and screen plate configurations of the device of FIG. 1.

FIG. 7 is a cross-sectional view of one embodiment of the interior of the outer cylinder of the device of FIG. 1.

FIG. 8 is a close-up cutaway cross-sectional view illustrating the height of the baffles in one embodiment of the present invention.

### DETAILED DESCRIPTION

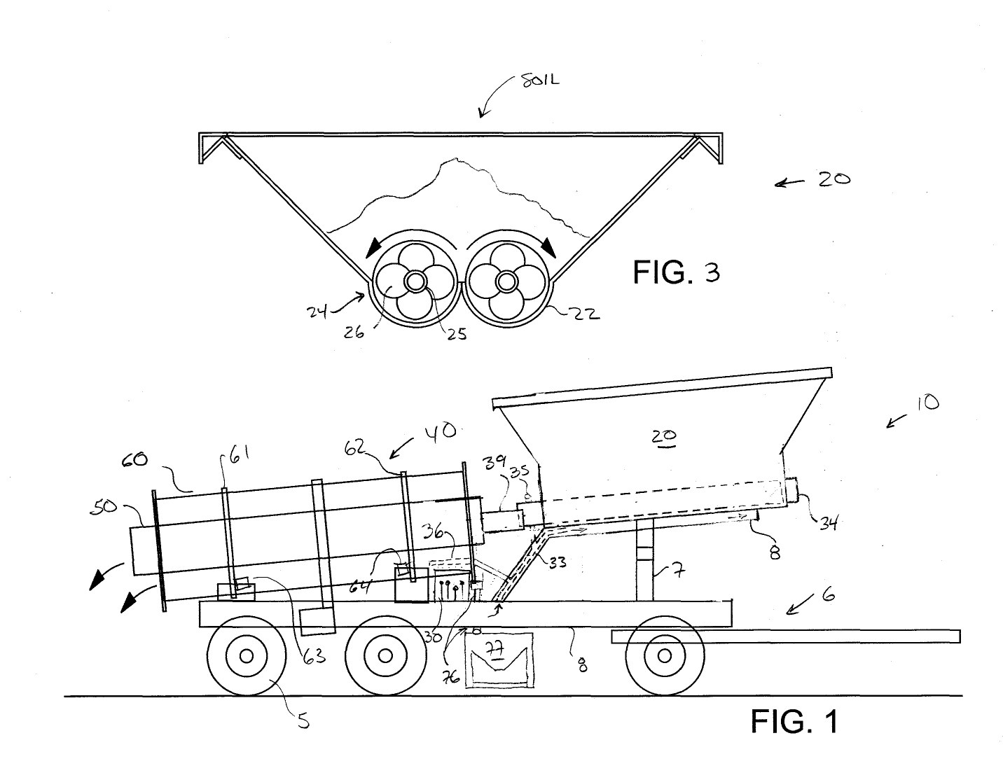

Referring to FIG. 1, a side elevation view of a concentrator device 10 in accordance with the present invention is shown. For pedagogical purposes, device 10 will be described with reference to FIG. 1 for use in extracting lead shot from soil. It should be recognized that the present invention may be used for separating/concentrating other than lead shot and from a substrate other than soil, for example, gold from river silt, or other.

A principal application of the present invention is to remove lead from soil at current or past shooting ranges, be they private, municipal, military or other. This is of particular importance when the shooting range is near an urban area or the soil hydrology is such that lead oxides may be transported from the site.

In one embodiment, among others, device 10 includes a frame 8 on which are mounted a hopper or pre-processor 20 and a concentrator structure or chamber 40. The frame may be configured as a trailer having wheels 5 and a tow assembly 6 for towing device 10 from site to site.

The hopper or pre-processor 20 receives soil extracted from a shooting range or other location. Soil is mechanically broken up in the hopper and mixed with water to dissolve soil away from lead and/or soften soil for down stream separation.

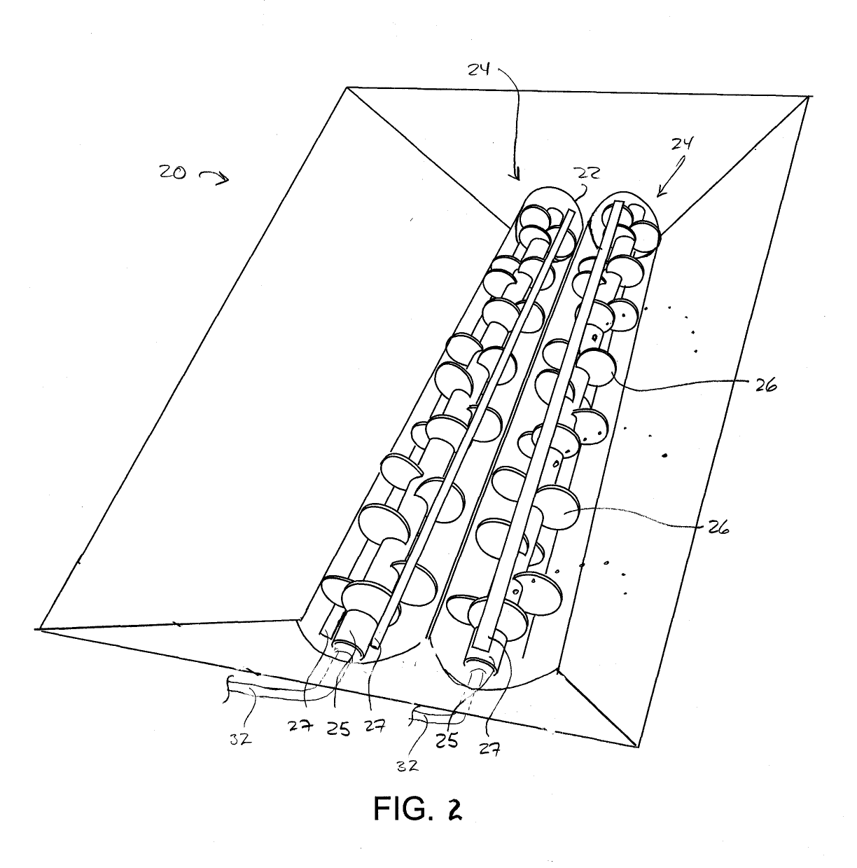

Referring to FIGS. 2-3, the hopper 22 may include one or more troughs 22 (two are shown). Situated in each trough is an auger type chopping member 24 that may have a central shaft 25, a plurality of substantially radially disposed blades 26, and one or more longitudinally disposed blades 27. Blades 26 may extend substantially perpendicular to shaft 25 (or otherwise) and be configured in radial arcs or other configurations that promote a chopping and mechanical break down of soil or other substrate.

In contrast to an auger, the blades 26 of member 24 are discontinuous and function to “chop” at soil in the trough, breaking down that soil, exposing it to water and separating the lead. The radial blades 26 chop in a first dimension and the longitudinal blades 27 chop in a second dimension, for more thorough break down of the input soil/substrate. The longitudinal blades may be arranged substantially perpendicularly to the radial blades (or otherwise arranged). They may be attached via welding at or near the tips of the radial blades. In addition, the longitudinal blades also prevent or impede dirt from clogging between the radial blades.

A hose 32 preferably feeds into each of the auger type chopping members 24. When activated by a user, water is released into hoses 32 and into shafts 25. A plurality of holes 28 are preferably formed in each shaft so that water, under pressure, exits through the holes as streams or jets that wet the soil in the hopper, preferably from the “inside” (ie, near the blades). In conjunction with blades 26,27, the water quickly slurrifies the water-soil mixture (providing some initial separation of lead from soil). Motors 34, discussed in more detail below, are attached to the shafts and power rotation of the shafts and blades. A motor control panel 30 is preferably mounted on frame 8 at an accessible location and is coupled to motor 34 for starting and stopping chopping member rotation and the direction and speed of rotation. Motor 34 is preferably a variable speed hydraulic motor (which are known in the art).

The slurry of water, soil, lead, rock and other debris exits the down stream end of the sloping troughs and is input to the concentration structure or chamber 40.

FIG. 1 illustrates a relationship between hopper 20 and chamber 40. A chute 39 from hopper 20 delivers the slurry to chamber 40.

Chamber 40 may include a first cylinder 50 that is mounted inside a second cylinder 60. The cylinders 50,60 are preferably concentric about a longitudinal axis and configured for tiltable and rotatable movement. While cylinders are shown, it should be recognized that other shapes such as hexagon, square, other polygon, elliptical or other may be used without departing from the present invention.

The exterior of outer cylinder 60 may have a first and a second roller guide 61,62. Four wheels (two are shown, the other two are opposite) are respectively positioned adjacent guides 61,62 (2 per guide) and support rotation of chamber 40. Motor 66 is preferably coupled to wheel 63 which functions as a drive wheel for chamber 40 (drive coupling between a motor and drive wheel are known in the art). The motor rotates wheel 63 which in turns rotates the chamber. The weight of the chamber is preferably distributed over the four wheels. Wheels 63 and 64 are shown with two other similarly located wheels being placed under the far side of the chamber (from the perspective of FIG. 1).

Referring to FIG. 4, a cross-sectional view of chamber 40 (just downstream of guide 62, at wheel 64) is shown. The outer cylinder 60 may include a shell 70 to which guides 61,62 (not visible in cross-section of FIG. 4) are welded or otherwise attached. The interior of this shell preferably includes a plurality of coiled flanges or baffles 72 that extend substantially continuously or in sections from the exit end to the input or upstream end of shell 70. As the shell turns, heavier objects such as lead shot are caught by the baffles, settle in the troughs between them, and are pushed upward (toward the upstream end of outer cylinder 60), while lighter matter such as soil and rock particles are washed downstream and out the exit end. In FIG. 4, 6 baffles are shown, the smaller radial line through the ring like structure labeled 72 indicating the individual baffles.

The baffles 72 are preferably arranged substantially in parallel or with greater spacing between baffles located near the downstream end of cylinder 60. Baffles 72 are preferably varied in height, being taller toward the exit end of the chamber and may preferably have an upstream tilt to create a pocket or recess that better holds the desired recoverable. Baffles 72 are discussed in more detail below with reference to FIGS. 7 and 8.

A plurality of frame members 42 are preferably welded between the inner and outer cylinders. These transfer motion from drive wheel 63 and outer cylinder 60 through to inner cylinder 50, thereby rotating the inner cylinder with the outer cylinder.

Inner cylinder 50 may have a range of configurations. In one configuration, shown in FIGS. 4-6, cylinder 50 includes a cylindrical frame 51 that defines a plurality of openings 52. Each opening 52 is covered with a plate or panel 54 that may be welded, bolted or otherwise attached to the frame. The openings 52 may be partially or fully wedge-shaped or rectangular or otherwise shaped.

Referring to FIG. 5, a side elevation view of one embodiment of inner cylinder 50 is shown. Phantom lines indicate the edges of opening 52. Screen panel or plate 54 is provided over opening 52 and has a plurality of screen or pass through openings 56. The inner cylinder and pass through opening arrangement are designed to separate rocks and other larger objects from the slurry stream.

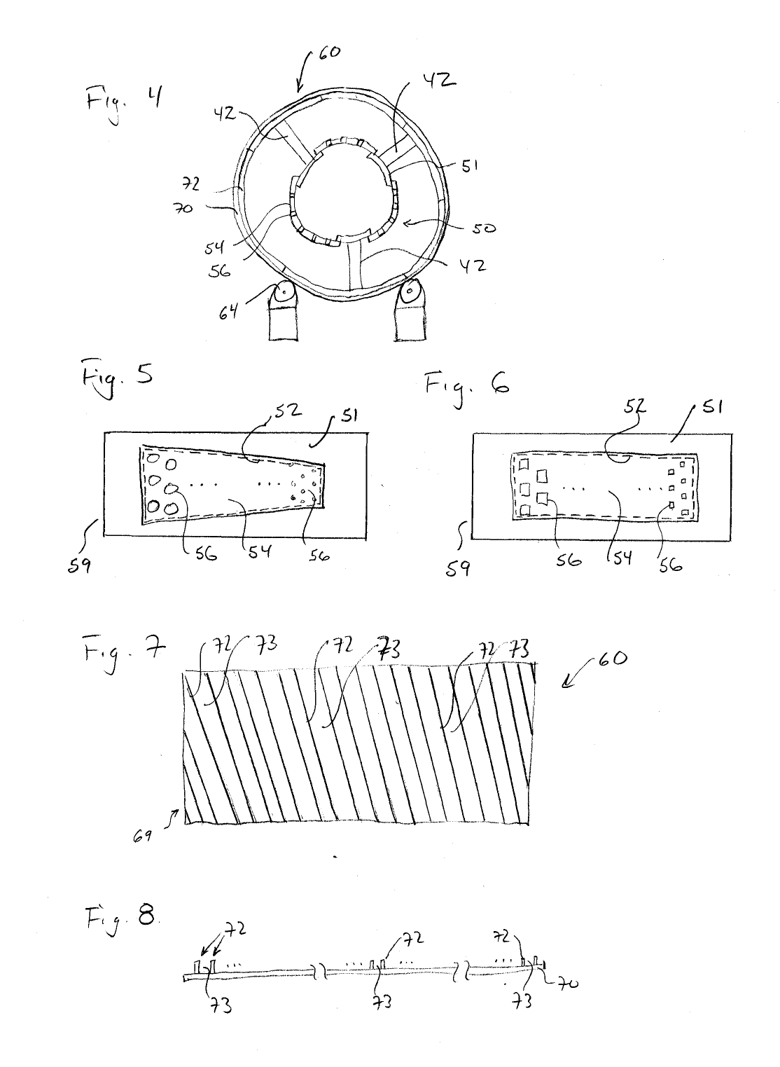

FIG. 6 illustrates a view similar to that of FIG. 5 yet with opening 52 being substantially rectangular and with plate 54 have square pass through openings. In one embodiment of the device of FIG. 6, the screen or pass through openings may be 1″ across near the input end and 2″ across near the output end, being varied or staggered in size between these sizes.

Chamber 40 is sloped so that the slurry components generally flow or move downstream from the entrance to the exit (the material caught in the troughs 73 between baffles 72 being an exception as it moves upstream due to rotation of the chamber and the upward spiraling configuration of the baffles). The slope of chamber 40 (from horizontal) may vary based on conditions, particle sizes, rate of slurry input, amount of rinse water, among other factors. A hydraulic extension leg 7 or the like is preferably provided toward the input end of the chamber 40 and/or hopper 20 to raise or lower this end to adjust tilt. Tilt and water flow (primarily water flow) determine the rate of travel of soil and rock, etc., through device 10.

Slurry components entering chamber 40 exit through three paths. Larger objects such as rocks, roots or other objects too large to pass through screen openings 56 are retained in the inner cylinder and exit the inner cylinder at output or exit end 59. Soil particles, water, lead/lead shot, smaller rocks and pebbles and the like fall through pass through openings 56 into the trough arrangement of the outer cylinder. From there, soil particles, smaller rocks and similar light material flow or are pushed out the exit end by water flowing down the interior of the outer cylinder. The heavier lead shot (or gold, etc.), however, is caught by the baffles 72 and is moved upstream as the cylinder rotates. This lead shot is output at the upstream end of the outer cylinder and slides/falls into a tube 76 that delivers it to a collection tub 77.

FIGS. 5 and 6 illustrate that the size of the pass through openings 56 may vary along the length of the inner cylinder. This may facilitate matter distribution, sorting and proper processing of rocks and soil clumps from the input slurry stream.

It should be recognized that exchangeable plates 54 are optional. Pass through openings 56 could be created directly in the “tube” of the inner cylinder. However, the exchangeable plates permit modification of the size and arrangement of pass through openings 56 to accommodate different conditions, different recovery targets, and other considerations.

Referring to FIG. 7, a cross-sectional view of one embodiment of the interior of outer cylinder 60 is shown. FIG. 7 illustrates that baffles 72 and the corresponding troughs 73 they define are coiled and spiral up the interior of shell 70. The baffles are preferably made of steel and are welded to the interior of shell 70. Again, while substantially parallel baffles are shown in FIG. 7, an increase in spacing between the baffles toward the downstream end may improve performance. For example, the baffles may be spaced 3″ apart towards the input (upstream) and 6″ apart toward the exit, changing linearly or staggeredly in between.

Referring to FIG. 8, a close-up cutaway cross-sectional view illustrating the height of baffles 72 in one embodiment of the present invention is shown. In the embodiment of FIG. 8, the height of the baffles is varied, being taller at the downstream end and smaller at the upstream end. In one embodiment for use in extracting conventional lead shot from soil, the upstream height is approximately ⅜″ while the downstream height is approximately 1½″. The height between the upstream and downstream ends may vary linearly, be staggered or be otherwise shaped. For example, in one embodiment, the baffle height varies in quarters ranging from ⅜″ to ¾″ to 1″ to 1½″ from upstream end to downstream end. The varied baffle height arrangement is more effective in separating lead shot from soil and rock than prior art arrangements.

In the embodiment of FIG. 8, the baffles present a flat face and preferably a substantially 90 degree angle from the shell. The baffles may vary 10, 20 or 30 or more degrees from 90 without departing from the present invention. In one embodiment, the baffles have an upstream tilt of 3-25 degrees and more preferably 5 to 15 or 20 degrees to create that recess to hold recoverables.

In addition to water added to hopper 20 to form the input slurry, water is strategically delivered at other key points in the process. A plurality of hoses 33 are coupled to frame 8 (and to a water supply and control 30). They deliver water to a sprinkler head/nozzle 35 at the output of the hopper and a sprinkler head/nozzle 36 at the upstream end of the outer cylinder 60. Sprinkler heads/nozzle 35,36 may be an extended linear sprinkler or otherwise arranged. Sprinkler 35 further saturates the slurry and sprinkler 36 washes rocks and soil downstream, away from the lead shot.

While various motors may be used, hydraulic motors and control system 30 are preferably used to actuate device 10. Variable-speed hydraulic motors are preferably used to turn the chopper members 24, the drive wheel 63, and the extension leg 7, among other components. Hydraulic motors offer variable speed control and tend to wear well in the conditions of their intended use, among other benefits.

It should be recognized that the present invention may also be used to separate and recovery gold or other heavier metals. Furthermore, the concentrator chamber 40 may be used without the hopper 20 for lead, gold or other. A screened soil shaker may be used upstream of the hopper or the concentrator chamber. For use in gold recovery, particularly in riparian zones with sandy soil and small river rocks and fines, high recovery can be achieved using concentration chamber 40 alone. Chamber 40 may be used on land or situated on a raft or barge. A dredge may be provided with a raft/barge mount concentrator chamber for use in in-situ gold recovery. The components of the concentrator of the present invention are scalable.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A device for recovering lead, gold or other heavier matter from soil, gravel or other substrates, comprising:
an screened inner cylinder;
a outer cylinder having baffles disposed on an interior surface thereof, the baffles being one or more of:
varied in height,
varied in their spacing from one another, and
tilted upstream; and
a variable speed motor for driving rotation of the outer cylinder.

2. The device of claim 1, further comprising a pre-processing hopper having at least one of:
a first movable blade for mechanically breaking up soil;
a water feed provided substantially at or below the height of the first movable blade; and
first and second movable blades being arranged at substantially different orientations.

3. The device of claim 3, wherein the inner cylinder includes screens that are one or more of:
removable; and
configured with openings of varied size, the openings becoming larger downstream.
